(19) United States
(12) Patent Application Publication
(10) Pub. No.: US 2012/0312937 A1
(43) Pub. Date: Dec. 13, 2012

(54) Portable and Storable Piñata Stand

(76) Inventors: Bruce Weber, Las Vegas, NV (US); Susan Weber, Las Vegas, NV (US)

(21) Appl. No.: 13/417,433

(22) Filed: Mar. 12, 2012

Related U.S. Application Data
(60) Provisional application No. 61/495,050, filed on Jun. 9, 2011.

(51) Int. Cl. F16M 11/04

(52) U.S. Cl. 248/125.2

(57) ABSTRACT

A portable, collapsible piñata support is disclosed having a base platform, and upstanding member, a support arm, and a pulley system tether. The base platform is a liquid or granular weight fillable element with an open interior volume, adapted to accept water or sand for stabilizing the device while in use. The upstanding member is a telescoping rod that is removably and pivotally attached to the base member and hingedly attached to the support arm. The support arm extends from the upstanding member to support the piñata, while a pulley system runs from the upstanding member to the distal end of the support arm for controlling the height of the piñata suspended therefrom. The device is quickly deployable and stowable by removing the base from the supports and collapsing the supports about their common hinge point.

### CROSS REFERENCE TO RELATED APPLICATION

This application claims the benefit of U.S. Provisional Application No. 61/495,050 filed on Jun. 9, 2011, entitled “Portable Storable Piñata Stand.”

### BACKGROUND OF THE INVENTION

1. Field of the Invention

The present invention relates to support stands. More specifically, the present invention relates to a collapsible, rotatable support stand for a piñata that allows control of the piñata during operation and a stowed configuration when not in use. The device is extendable from the ground, permits swiveling action of an upstanding support, rotation of the piñata arm and disassembly for a condensed volume when not in operation.

Piñatas are suspended containers adapted to be struck and broken open by individuals in an entertaining game or activity. The piñata is filled with toys or candy, and individuals can take turns breaking open the piñata, wherein the contents are revealed for consumption or enjoyment. A piñata is generally suspended by a tether and supported by a larger structure. The orchestrator of the event can control the height and movement of the piñata as an individual attempts to break it open, wherein the tether can be pulled or slackened as the user attempts to strike the piñata using a bat or other striking means. Traditionally, the tether is wrapped over a tree branch, connected to a cable or secure using another outdoor support.

In more open environments, and in indoor settings, adequate support may not be possible using the surroundings as a means for securing the piñata tether. For these instances, stands have been developed for supporting a suspended piñata. These stands have familiar design elements for the purpose of suspending a piñata by a tether without obstruction for a user attempting to strike the same. It is necessary to distance the upstanding support of these stands from a user, as the user is generally swinging a bat or baton, which can otherwise strike the upstanding portions of the stand. Further, the base of the stand must be adequately supported to prevent tipping. Most frames currently available providing an upstanding portion and a horizontal portion, whereby a tether can be attached to the distal end of the horizontal portion for controlling the height of the piñata during the activity.

These types of stand devices can be overly cumbersome and not easily related or stored. Still others require power tools for setting up the stand, which becomes a semi-permanent structure thereafter. This does not lend itself to the quick deployment or stowing of the stand or frame, and further limits the locations for which the devices can be utilized. The present invention provides a collapsible, easily deployed and stowable structure that is adapted for use in virtually all environments, including indoor and outdoor use. The base is supported by a volume of water or granular weight product, while an upstanding support hingedly attaches to a support arm carrying a tether in support of a suspended piñata. A pulley system allows a user standing beside the upstanding support to manipulate the tether and swivel the support during the piñata striking activities. The upstanding support is further telescoping to allow height adjustments. Afterwards, the support arm and is folded onto the upstanding support, which is separated from the base for quick stowage in a condensed form.

2. Description of the Prior Art

Stand devices and frames have been disclosed in the prior art for supporting a suspending piñata. These devices feature similar design elements and common drawbacks that limit their ability to deploy and stow in a rapid manner, and further permit the use of the device in all environments. Most are semi-static devices that provide little manipulation of the frame during operation, and lack the ability to condense into such a small volume when not in use. While adapted for their specific tasks and fulfilling a need in the art, these devices do not describe the elements of the present invention.

U.S. Pat. No. 6,412,736 to Zaragoza is one such device, which discloses a collapsible piñata hoist comprising a V-shaped base assembly, a vertical support pole assembly a horizontal support pole and a pulley assembly. The horizontal support pole makes a T-fitting with the vertical support pole, while the pulley assembly is utilized to control and manipulate a suspended piñata from the distal end of the horizontal support pole. The pulley tether is controlled by a user at the proximal end of the horizontal support pole. A number of locking pins are utilized to secure the assemblies together, while the V-shaped base provides a means to secure the assembly using fillable weight material receiving cavities as a counterweight. The Zaragoza device differs in construction, and similar does not allow swivel action about its base member. The device is not easily condensed into a smaller assembly, as provided by the folding and sliding members of the present invention.

U.S. Pat. No. 6,978,974 to Marasco further describes a collapsible piñata support assembly comprising a base having an upstanding sleeve. A telescoping pole is inserted into the upstanding sleeve to provide a vertical support, while an arm connects to the telescoping pole in a horizontal configuration to provide cantilevered support of a piñata from a tether that runs internally within the arm and out of its distal end. Fluid may be placed within the base of the stand for weighted support of the arm and supported piñata, while the arm further comprises an extension for moving the distal end thereof closer and farther from the vertical, telescoping pole. While providing a similar style piñata stand as the present invention, wherein a vertical and horizontal member are disclosed having telescoping features, the Marasco device lacks the added degrees of freedom provided by the present invention, along with its inherent collapsibility. The Marasco device does not swivel about its base, but rather the entire assembly must be tilted and moved using rearward-mounted wheels. The horizontal arm is further statically positioned at a right angle with regard to the vertical pole, wherein the present invention provide a rotatable hinged at this location, allowing user to manipulate the piñata using the tether, rotating the arm and further swiveling the upstanding member. These extra degrees of freedom add to the excitement while maneuvering a piñata as an individual attempts to break it open with a stick or bat.

U.S. Patent Application Publication Number 2007/0099534 to Alas describes a portable piñata mounting device comprising a frame member and a pulley member. The frame member is adapted to provide clearance for a suspended piñata at the end of the pulley member, along with space for an individual to engage the piñata. The frame of the Alas device is a truss member having two upstanding legs and a midpoint connection, whereby the pulley is adapted to be located. The frame is adapted to have at least one telescoping member for varying the lengths and height of the device. While providing a novel means for supporting a piñata and pulley therefor, the Alas device is an overly large apparatus for supporting such a device, and further it lacks the functionality and collapsibility of the present invention.

Finally, U.S. Patent Application Publication Number 2008/0073468 to Arroyo discloses a foldable piñata stand and methods for quick setup and disassembly of the piñata assembly. The stand comprises a first and second folding arms pivotally attached to a support assembly, wherein the first and second folding arms are mounted vertically and horizontally, respectively. The arms are pined together to form a static structure having a pulley device attached to the horizontal arm, which is used to support a suspended piñata. While providing a means to collapse and support a piñata, the Arroyo device similarly fails to provide a piñata stand with the same degrees of freedom and maneuverability of the piñata as provided by the present invention.

The present invention provides a new and novel piñata stand that is easily deployable in any given environment, requiring no external supports or considerations, while also allowing the user to separate and condense the frame into a smaller volume for improved storage and transport. The telescopic, swiveling action of the frame, along with its construction substantially diverge in design elements from the prior art; consequently it is clear that there is a need in the art for an improvement to existing piñata support stand devices. In this regard the instant invention substantially fulfills these needs.

### SUMMARY OF THE INVENTION

In view of the foregoing disadvantages inherent in the known types of piñata support stand now present in the prior art, the present invention provides a new piñata support stand wherein the same can be utilized for providing convenience for the user when transporting, deploying or stowing a piñata stand that provides improved utility with regard to piñata games.

It is therefore an object of the present invention to provide a new and improved piñata support stand device that has all of the advantages of the prior art and none of the disadvantages.

Another object of the present invention is to provide a portable and easily deployable support stand for a piñata, wherein the device may be used in a variety of environments.

Another object of the present invention is to provide collapsible piñata stand that allows a user to easily transport or store the stand device when not in use.

Yet another object of the present invention is to provide an adjustable stand device that provides height adjustment, swivel adjustment and a pulley system that is used to control the suspended piñata.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the piñata stand of the present invention.

FIG. 2 shows a front view of the piñata stand of the present invention.

FIG. 3 shows a collapsed view of the upstanding member and support arm.

### DETAILED DESCRIPTION OF THE INVENTION

Reference is made herein to the attached drawings. Like reference numerals are used throughout the drawings to depict like or similar elements of the piñata support stand. For the purposes of presenting a brief and clear description of the present invention, the preferred embodiment will be discussed as used for supporting a suspending piñata and providing a device that is easily deployed, stowed and operated. The figures are intended for representative purposes only and should not be considered to be limiting in any respect.

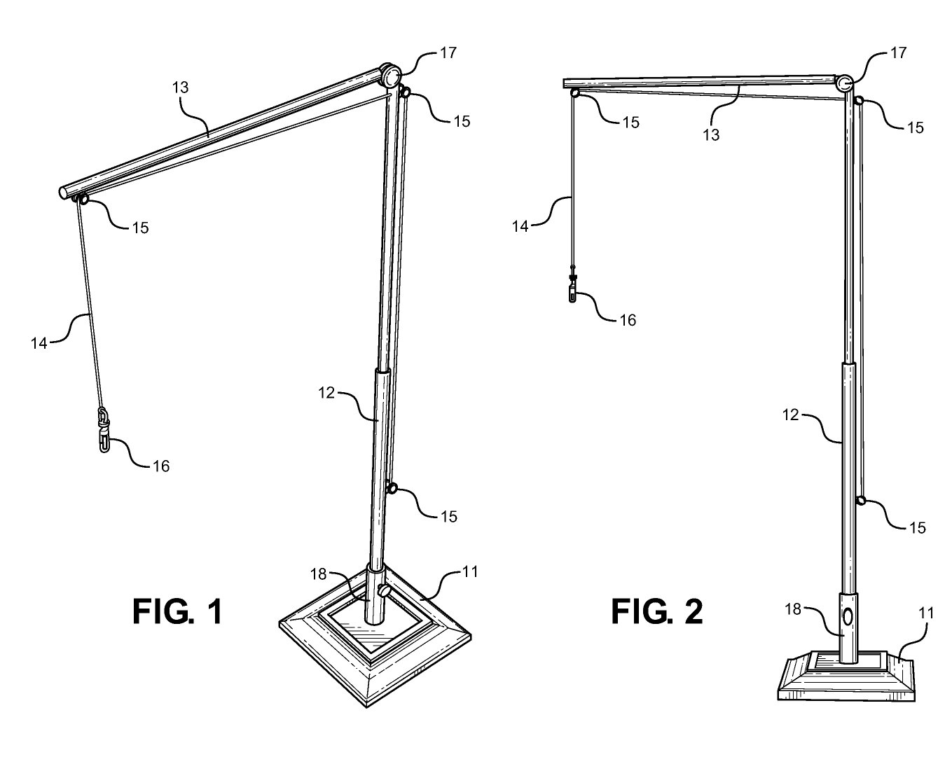

Referring now to FIG. 1, there is shown an overhead perspective view of the piñata stand of the present invention, wherein the device is deployed in a working position. The stand comprising fillable base member 11 having an interior volume and fill location for loading its interior with a weighted, fluid or granular substance (such as water or sand) for the purposes of providing a stable support for the upstanding and outstretched regions of the device and an attached piñata. The base 11 is adapted to encompass a larger surface area to distribute the weight of the fill material and prevent tipping due to movement of the piñata and loads imparted on the stand during operation. Attached to the base 11 is the lower end of an upstanding member 12, comprising a telescoping, vertical support that controls the overall height of the piñata. At the upstanding member 12 upper end is a hinge mechanism 17 that hingedly attaches the upstanding member 12 to a support arm 13, which operates as a horizontal, cantilever support for the suspended piñata. The support arm 13 and the upstanding member 12 are adapted to fold together in a stowed position or spread apart to form a perpendicular working position. This allows the arm 13 to achieve a horizontal working position. The hinge 17 preferably includes a locking feature to secure the two members in a stowed position or a working position, whereby a release mechanism allows the hinge to operate and the members to be folded or unfolded.

Running along the length of both the upstanding member 12 and the support arm 13 is a series of pulleys 15 that form a system to operate piñata tether 14. In a particular embodiment, the tether 14 attaches to a location along the upstanding member 12, runs upward to a pulley at the member 12 upper end, and finally extends to a pulley at the distal end of the support arm 13 before engaging a suspended piñata. The tether 14, therefore, runs along the stand members with minimal clearance, reducing interference therewith or with environmental objects nearby. The user controls the tension on the tether 14 and therefore the piñata location by tugging the tether along the upstanding member, while a user beneath the support arm 13 and piñata attempt to strike the piñata and release its contents. The tether 14 attaches to a piñata using an appropriate attachment means 16, shown in FIG. 1 as a clasp or clip.

Referring now to FIG. 2, there is shown a front view of the piñata stand of the present invention, wherein the device is displayed in a working position. The upstanding member 12 is expanded to a given height to allow adequate clearance of the support arm 13 and enough distance to allow the piñata to be raised above a user's head while engaging in the piñata striking activities. The member 12 may be statically or rotatably attached 18 to the base member 11 to allow swiveling of the support arm 13, and further movement of the piñata. The tether 14 of the device runs along the supports and over a series of pulleys 15 to suspend a piñata with a largely vertical length of tether. Once attached 16 to the tether, the piñata can be raised or lowered, and further rotated away from a swinging user, adding enjoyment and difficulty to the action of striking and opening the piñata.

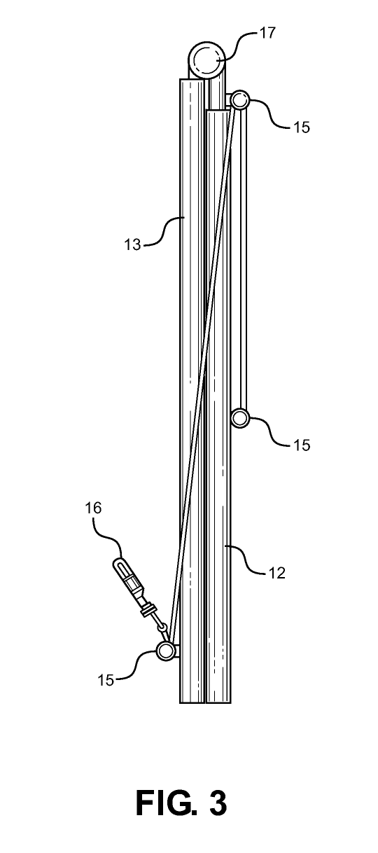

Referring now to FIG. 3, there is shown a view of the present invention in a condensed, stowed configuration, wherein the members of the stand are folded together. As shown, the support arm 13 is folded against the upstanding support 12. The hinge 17 allows the two to fold together, allowing the user to neatly carrying and store the device in a smaller area. The telescoping upstanding support 12 is condensed into its smallest length, and the tether may then be wrapped around the assembly. The hinge preferably employs a locking detent in the condensed and open position, wherein this stowed configuration is secured until the hinge is released and the device is rotated into a working position. The base member is separated from the support members and drained of its weighted interior. In this way, the device may be easily transported and setup in any location without the use of any hand tools. When the device is not in use, it can be conveniently stored in a condensed form.

The present invention provides a simple means for supporting a piñata, and one that is easily deployable and operable. The supports preferably comprise tubular members, wherein the upstanding member comprises a telescoping means to raise the support arm to a height well above the reach of an individual attempting to strike a suspended piñata. The members are preferably constructed of a durable material that can withstand the load imparted by the piñata tether on the pulleys, while resisting deflection during operation. The device too must be easily handled and carried when condensed; therefore the material should be adequate to support the desired loads while minimizing the heft of the condensed device. The base member can be any shape that provides an interior cavity for filling with weighted contents, while providing a base that is wide enough to prevent tipping of the device. It is not desired to limit the disclosed invention to a specific type of material or dimensions, but rather it is desired to disclose a piñata stand with improved utility and functionality over the devices currently available and in the prior art.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable and storable piñata stand, comprising:
a base member, an upstanding member hingedly attaching to a support arm and a tether;
said base member having an interior volume and fill location for placing weighted liquid or granular material therein;
said upstanding member having an upper and lower end and a telescoping length;
said upstanding member lower end removably attaching to said base member, said upper end attaching to a hinge;
said hinge connecting said upstanding member and support arm;
said tether running along said upstanding member and said support arm via a plurality of pulleys, said tether adapted to vertically hang from said support arm distal end and support a suspended piñata via a piñata attachment means;
said upstanding member and said support arm adapted to be removed from said base member, folded together via said hinge and stowed in a condensed form.

2) The device of claim 1, wherein said hinge further comprises a detented hinge, permitting secure positioning of said upstanding member and said support arm parallel alignment to form a stowed state, or positioned perpendicularly from one another in a working position.

3) The device of claim 1, wherein said hinge further comprises:
a locking hinge, permitting said upstanding member and said support arm to be locked into a parallel, stowed state, or locked into a perpendicular working position;
said locking hinge having a release for changing said hinge position.

4) The device of claim 1, wherein said upstanding member removable attachment to said base member permits rotation of said member with respect to said base member.
